(19) United States
(12) Patent Application Publication
(10) Pub. No.: US 2026/0188575 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Seung Won KIM, Suwon-si (KR); Eun Jong LEE, Suwon-si (KR); Yong Koo KIM, Suwon-si (KR)

(73) Assignee: SAMSUNG ELECTRO-MECHANICS CO., LTD., Suwon-si (KR)

(21) Appl. No.: 19/392,305

(22) Filed: Nov. 18, 2025

(30) Foreign Application Priority Data
Dec. 26, 2024 (KR) 10-2024-0197717

(51) Int. Cl. H01G 4/005; H01G 4/30

(52) U.S. Cl. CPC H01G 4/005; H01G 4/30

(57) ABSTRACT

A multilayer electronic component includes a body having a dielectric layer and internal electrodes alternately laminated in a first direction. The body has first and second surfaces opposing each other in the first direction, third and fourth surfaces connected to the first and second surfaces and opposing each other in a second direction, and fifth and sixth surfaces connected to the first to fourth surfaces and opposing each other in a third direction. External electrodes are disposed on the third and fourth surfaces. Each internal electrode includes first and second conductor portions spaced apart from each other in the third direction with a separation portion interposed therebetween. The body further includes a first margin portion between the fifth surface and the internal electrode and a second margin portion between the sixth surface and the internal electrode.

### CROSS-REFERENCE TO RELATED APPLICATION(S)

This application claims the benefit of priority to Korean Patent Application No. 10-2024-0197717 filed on Dec. 26, 2024 with the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

An MLCC may be used as a component of various electronic devices due to having a small size, ensuring high capacitance and being easily mounted. With the miniaturization and high-output power of various electronic devices such as computers and mobile devices, demand for miniaturization and implementation of high capacitance of multilayer ceramic capacitors has also been increasing.

In addition, with miniaturization and implementation of high capacitance of a multilayer ceramic capacitor, a mounting density of the multilayer ceramic capacitor has also been increasing.

A temperature of a multilayer ceramic capacitor may increase depending on an applied voltage, usage environment, or the like. An increase in temperature of the multilayer ceramic capacitor may affect electrical characteristics and further lead to a decrease in reliability, and thus it may be necessary to control heat generation characteristics of the multilayer ceramic capacitor.

### PRIOR ART DOCUMENT

### Patent Document

(Patent Document 1) JP 2004-193352 A

### SUMMARY

An aspect of the present disclosure is to provide a multilayer electronic component having excellent heat generation characteristics.

Another aspect of the present disclosure is to provide a multilayer electronic component having excellent reliability.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and an internal electrode alternately disposed with the dielectric layer in a first direction, the body having a first surface, and a second surface, opposing each other in the first direction, a third surface and a fourth surface connected to the first surface and the second surface, the third surface and the fourth surface opposing each other in a second direction, and a fifth surface and a sixth surface connected to the first to fourth surfaces, the fifth surface and the sixth surface opposing each other in a third direction, and an external electrode disposed on the third surface and the fourth surface. The internal electrode may include first and second conductor portions disposed to be spaced apart from each other in the third direction with a separation portion interposed therebetween. The body may include a first margin portion that is a region between the fifth surface and the internal electrode, and a second margin portion that is a region between the sixth surface and the internal electrode. When widths in the third direction of the body, the first margin portion, the separation portion, and the second margin portion are referred to as W, MW1, CW, and MW2, respectively, 0.08<MW1/W<0.20, 0.08<MW2/W<0.20, and 0.08<CW/W<0.3 may be satisfied.

According to example embodiments of the present disclosure, an internal electrode may include first and second conductor portions, disposed to be spaced apart from each other in a third direction with a separation portion interposed therebetween, thereby improving heat generation characteristics of a multilayer electronic component.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic cross-sectional view taken along line III-III′ of FIG. 1;

FIG. 5 is a schematic cross-sectional view taken along line IV-IV′ of FIG. 1;

FIG. 6 is an exploded view of the body of FIG. 1;

FIG. 7 is a cross-sectional view, corresponding to FIG. 2, of a multilayer electronic component of an example according to the related art.

FIG. 8 is a graph comparing capacitances and dissipation factors (DFs) of an example according to the related art and an example according to the present disclosure.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a first direction, a lamination direction, or a thickness (T) direction, a Y-direction may be defined as a second direction or a length (L) direction, and a Z-direction may be defined as a third direction or a width (W) direction.

### Multilayer Electronic Component

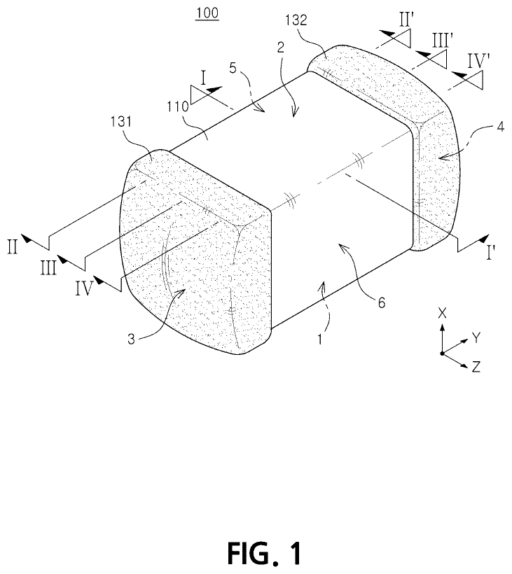

FIG. 1 is a schematic perspective view of a multilayer electronic component according to an example embodiment of the present disclosure.

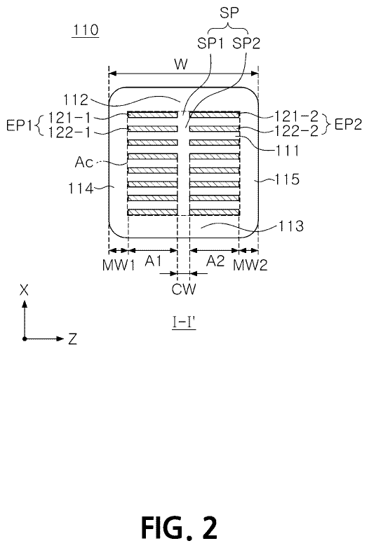

FIG. 2 is a schematic cross-sectional view taken along line I-I′ of FIG. 1.

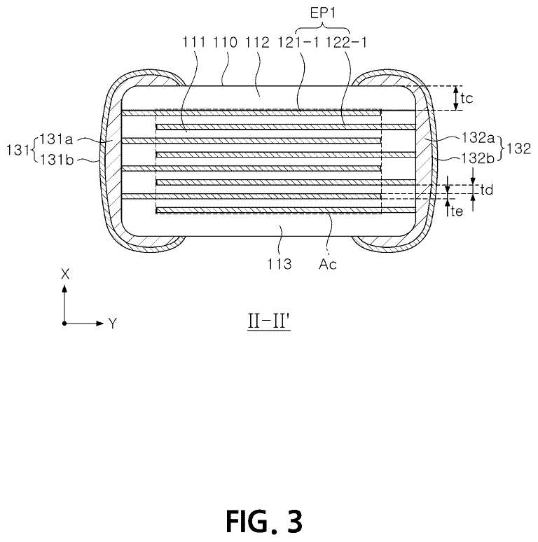

FIG. 3 is a schematic cross-sectional view taken along line II-II′ of FIG. 1.

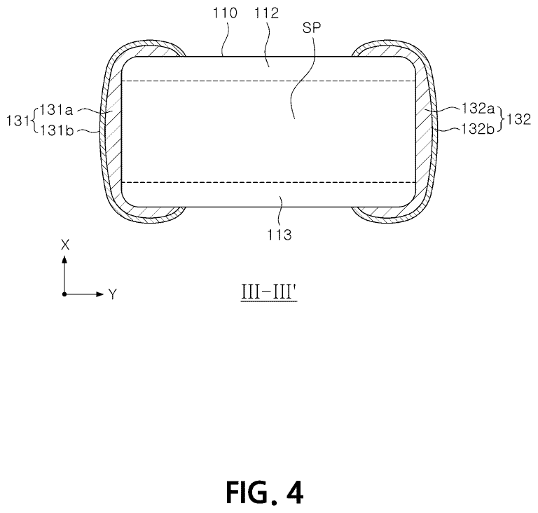

FIG. 4 is a schematic cross-sectional view taken along line III-III′ of FIG. 1.

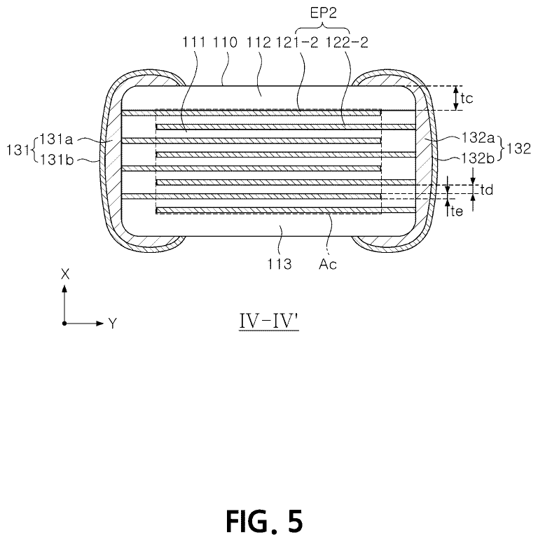

FIG. 5 is a schematic cross-sectional view taken along line IV-IV′ of FIG. 1.

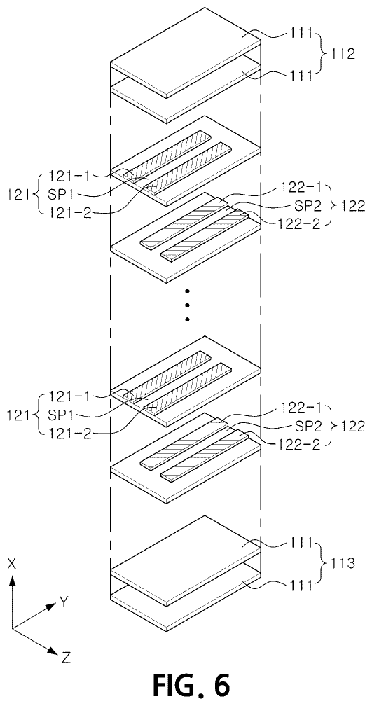

FIG. 6 is an exploded view of the body of FIG. 1.

Hereinafter, a multilayer electronic component 100 according to an example embodiment of the present disclosure will be described in detail with reference to FIGS. 1 to 6. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 including a dielectric layer 111 and internal electrodes 121 and 122 alternately laminated with the dielectric layer in a first direction, the body having a first surface 1 and a second surface 2 opposing each other in the first direction, a third surface 3 and a fourth surface 4 connected to the first and second surfaces, the third surface and the fourth surface opposing each other in a second direction, and a fifth surface 5 and a sixth surface 6 connected to the first to fourth surfaces, the fifth surface and the sixth surface opposing each other in a third direction, and external electrodes 131 and 132 disposed on the third surface and the fourth surface. The internal electrodes may include a first conductor portion EP1 and a second conductor portion EP2 disposed to be spaced apart from each other in the third direction with a separation portion SP interposed therebetween. The body may include a first margin portion 114 that is a region between the fifth surface and the internal electrode, and a second margin portion 115 that is a region between the sixth surface and the internal electrode. When widths in the third direction of the body, the first margin portion, the separation portion, and the second margin portion are referred to as W, MW1, CW, and MW2, respectively, 0.08<MW1/W<0.20, 0.08<MW2/W<0.20, and 0.08<CW/W<0.3 may be satisfied.

With miniaturization and implementation of high capacitance of a multilayer ceramic capacitor, a mounting density of the multilayer ceramic capacitor has also been increasing.

A temperature of a multilayer ceramic capacitor may increase depending on an applied voltage, usage environment, or the like. An increase in temperature of the multilayer ceramic capacitor may affect electrical characteristics and further lead to a decrease in reliability, and thus it may be necessary to control heat generation characteristics of the multilayer ceramic capacitor.

According to the related art, in order to control heat generation characteristics, a method of reducing voltage applied to a multilayer ceramic capacitor or reducing equivalent series resistance (ESR) has been used. Conversely, according to an example embodiment of the present disclosure, the internal electrodes 121 and 122 may include the first conductor portion EP1 and the second conductor portion EP2 disposed to be spaced apart from each other in the third direction with the separation portion SP interposed therebetween, thereby reducing a value of current flowing through each of the conductor portions EP1 and EP2. Accordingly, heat generated in each of the conductor portions EP1 and EP2 may be reduced, thereby improving heat generation characteristics. In addition, heat generated in each of the conductor portions EP1 and EP2 may be dissipated through the separation portion SP and the margin portions 114 and 115, thereby suppressing an increase in temperature of a multilayer ceramic capacitor.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in a second direction, and fifth and sixth surfaces 5 and 6 connected to the third and fourth surfaces 3 and 4, the fifth and sixth surfaces 5 and 6 opposing each other in a third direction. The first surface 1 may be a mounting surface disposed to oppose a substrate when mounted on the substrate.

As margin regions in which the internal electrodes 121 and 122 are not disposed on the dielectric layer 111 overlap each other, a step portion may be formed due to thicknesses of the internal electrodes 121 and 122, such that a corner, connecting the first surface and the third to fifth surfaces to each other, and/or a corner, connecting the second surface and the third to fifth surfaces to each other, may shrink toward a center in the first direction of the body 110, with respect to the first surface or the second surface. Alternatively, due to shrinkage behavior of the body during a sintering process, a corner, connecting the first surface 1 and the third to sixth surfaces 3, 4, 5, and 6 to each other, and/or a corner, connecting the second surface 2 and the third to sixth surfaces 3, 4, 5, and 6 to each other, may shrink toward the center in the first direction of the body 110, with respect to the first surface or the second surface. Alternatively, in order to prevent chipping defects, an additional process may be performed to round corners connecting respective surfaces of the body 110 to each other. Accordingly, the corner, connecting the first surface and the third to sixth surfaces to each other, and/or the corner, connecting the second surface and the third to sixth surfaces to each other, may have a round shape.

In order to suppress a step portion caused by the internal electrodes 121 and 122, internal electrodes may be laminated and then cut to be exposed to the fifth and sixth surfaces 5 and 6 of the body. Thereafter, one dielectric layer or two or more dielectric layers may be laminated on both side surfaces of a capacitance formation portion Ac in the third direction (width direction) to form margin portions 114 and 115. In this case, a portion, connecting a first surface and fifth and sixth surfaces to each other, and a portion, connecting a second surface and the fifth and sixth surfaces to each other, may not shrink.

A plurality of dielectric layers 111, included in the body 110, may be in a sintered state, and adjacent dielectric layers 111 may be integrated with each other such that boundaries therebetween are not readily apparent without using a scanning electron microscope (SEM). The number of laminated dielectric layers is not limited, and may be determined in consideration of a size of the multilayer electronic component. For example, the body may be formed by laminating 400 or more dielectric layers.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles. As a more specific example, the barium titanate-based (BaTiO₃)-based powder particles may be at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and CaZrO₃-based paraelectric powder particles may be (Ca₁₋ₓSrₓ)(Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or (Ca₁₋ₓSrₓ)(Zr_{1-y}Ti_{y})O₃ (0<x<1, 0<y<1).

The body 110 may include a capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor, and may be formed by repeatedly laminating a plurality of first and second internal electrodes 121 and 122 on each other with the dielectric layer 111 interposed therebetween.

The cover portions 112 and 113 may include an upper cover portion 112 disposed on the upper portion in the first direction of the capacitance formation portion Ac, and a lower cover portion 113 disposed on the lower portion in the first direction of the capacitance formation portion Ac.

The upper cover portion 112 and the lower cover portion 113 may be respectively formed by laminating one dielectric layer or two or more dielectric layers on upper and lower surfaces of the capacitance formation portion Ac in a thickness direction, and may basically serve to prevent the internal electrode from being damaged due to physical or chemical stress.

The upper cover portion 112 and the lower cover portion 113 may not include the internal electrode, and may include a material the same as that of the dielectric layer 111.

That is, the upper cover portion 112 and the lower cover portion 113 may include a ceramic material, and may include, for example, a barium titanate (BaTiO₃)-based ceramic material.

A thickness of each of the cover portions 112 and 113 is not limited. However, in order to easily achieve miniaturization and high capacitance of the multilayer electronic component, a thickness (tc) of each of the cover portions 112 and 113 may be 15 μm or less.

An average thickness (tc) of each of the cover portions 112 and 113 may refer to a size in the first direction of each of the cover portions 112 and 113, and may have a value obtained by averaging sizes in the first direction of each of the cover portions 112 and 113, measured at five points spaced apart t from each other at equal intervals of an upper portion or lower portion of the capacitance formation portion Ac.

In addition, the margin portions 114 and 115 may be disposed on side surfaces of the capacitance formation portion Ac, respectively.

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces in a width direction of the ceramic body 110, respectively.

As illustrated in FIG. 5, the margin portions 114 and 115 may refer to regions between both ends of each of the first and second internal electrodes 121 and 122 and an interface of the body 110 in a cross-section of the body 110 cut in a width-thickness (W-T) direction.

The margin portions 114 and 115 may basically serve to prevent the internal electrode from being damaged due to physical or chemical stress.

The margin portions 114 and 115 may be formed by forming the internal electrode by coating a conductive paste on a ceramic green sheet, except for a portion of the ceramic green sheet on which a margin portion is to be formed.

In addition, in order to suppress a step portion caused by the internal electrodes 121 and 122, the internal electrodes may be laminated and then cut to be exposed to the fifth and sixth surfaces 5 and 6 of the body. Thereafter, one dielectric layer or two or more dielectric layers may be laminated on both side surfaces of the capacitance formation portion Ac in the third direction (width direction) to form the margin portions 114 and 115.

A width of each of the margin portions 114 and 115 is not limited. However, in order to easily achieve miniaturization and high capacitance of the multilayer electronic component, an average width of each of the margin portions 114 and 115 may be 15 μm or less.

The average width of each of the margin portions 114 and 115 may be an average size in the third direction (MW1) of a region in which the internal electrode is spaced apart from the fifth surface or an average size in the third direction (MW2) of a region in which the internal electrode is spaced apart from the sixth surface, and may have an average value of sizes in the third direction of each of the margin portions 114 and 115, measured at five points spaced apart from each other at equal intervals of a side surface of the capacitance formation portion Ac.

Accordingly, in an example embodiment, each of the average sizes in the third direction (MW1 and MW2) of regions in which the internal electrodes 121 and 122 are spaced apart from the fifth and sixth surfaces may be 15 μm or less.

The internal electrodes 121 and 122 may include a first conductor portion EP1 and a second conductor portion EP2 disposed to be spaced apart from each other in the third direction with a separation portion SP interposed therebetween, and the body may include a first margin portion 114 that is a region between the fifth surface and the internal electrode, and a second margin portion 115 that is a region between the sixth surface and the internal electrode. When widths in the third direction of the body, the first margin portion, the separation portion, and the second margin portion are referred to as W, MW1, CW, and MW2, respectively, 0.08<MW1/W<0.20, 0.08<MW2/W<0.20, and 0.08<CW/W<0.3 may be satisfied.

The internal electrodes 121 and 122 may include the first and second conductor portions EP1 and EP2 disposed to be spaced apart from each other in the third direction with the separation portion SP interposed therebetween, thereby reducing a value of current flowing through each of the conductor portions EP1 and EP2. Accordingly, heat generated in each of the conductor portions EP1 and EP2 may be reduced, thereby improving heat generation characteristics.

In addition, 0.08<MW1/W<0.20, 0.08<MW2/W<0.20, and 0.08<CW/W<0.3 may be satisfied, heat generated in each of the conductor portions EP1 and EP2 may be dissipated through the separation portion SP and the margin portions 114 and 115, thereby suppressing an increase in temperature of the multilayer ceramic capacitor.

When MW1/W and/or MW2/W is 0.08 or less, it may be difficult to protect the internal electrode from external impacts, which may lead to a decrease in reliability. When MW1/W and/or MW2/W is 0.20 or more, a capacitance per unit volume of the multilayer electronic component may be reduced. Accordingly, 0.08<MW1/W<0.20 and 0.08<MW2/W<0.20 may be preferably satisfied, and 0.10≤MW1/W≤0.15 and 0.10≤MW2/W≤0.15 may be more preferably satisfied.

When CW/W is 0.08 or less, the first conductor portion EP1 and the second conductor portion EP2 may be disposed to be excessively close to each other, current may not split and flow through both the first and second conductor portions EP1 and EP2. Conversely, when CW/W is 0.30 or more, a capacitance per unit volume of the multilayer electronic component may be reduced or the margin portion may not be secured, resulting in a decrease in reliability. Accordingly, 0.08<CW/W<0.3 may be preferably satisfied, and 0.10≤CW/W<0.20 may be more preferably satisfied.

In an example embodiment, W, MW1, CW, and MW2 may satisfy 0.10<MW1/W≤0.15, 0.10≤MW2/W<0.15, and 0.10≤CW/W≤0.20.

In an example embodiment, W, MW1, CW, and MW2 may satisfy (MW1+CW+MW2)/W≤0.40.

When (MW1+CW+MW2)/W is greater than 0.40, the capacitance per unit volume of the multilayer electronic component may be reduced.

In an example embodiment, MW1, MW2, and CW may satisfy MW1<CW and MW2<CW.

It may be difficult to dissipate heat generated in the body to be dissipated through the margin portions 114 and 115 rather than through the separation portion SP, such that a greater width CW of the separation portion may be secured, thereby further suppressing an increase in temperature of the multilayer ceramic capacitor.

When widths in the third direction of the first and second conductor portions EP1 and EP2 are referred to as A1 and A2, respectively, A1+A2 may be 0.60 or more.

When A1+A2 is less than 0.60, the capacitance per unit volume of the multilayer electronic component may be reduced.

In this case, A1 and A2 may be substantially equal to each other. As A1 and A2 are substantially equal to each other, heat generated in the first and second conductor portions EP1 and EP2 may be similar, which may be more advantageous in terms of heat generation characteristics.

However, the present disclosure is not limited thereto, and A1 and A2 may be different from each other.

In an example embodiment, the internal electrodes 121 and 122 may include the first internal electrode 121 led out to the third surface, and the second internal electrode 122 led out to the fourth surface.

The first and second internal electrodes 121 and 122 may be alternately disposed to oppose each other with the dielectric layer 111, included in the body 110, interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

A conductive metal, included in the internal electrodes 121 and 122, may include at least one of Ni, Cu, Pd, Ag, Au, Pt, In, Sn, Al, W, Ti, and alloys thereof, but the present disclosure is not limited thereto.

The internal electrodes 121 and 122 may be formed by printing an internal electrode conductive paste, including metal powder particles, a binder, an organic solvent, or the like, to a predetermined thickness on the ceramic green sheet using a screen-printing method or gravure-printing method.

In an example embodiment, the first internal electrode 121 may include first-first and second-first conductor portions 121-1 and 121-2 disposed to be spaced apart from each other in the third direction with a first separation portion SP1 interposed therebetween, and the second internal electrode 122 may include first-second and second-second conductor portions 122-1 and 122-2 disposed to be spaced apart from each other in the third direction with a second separation portion SP2 interposed therebetween.

The first-first and second-first conductor portions 121-1 and 121-2 may be connected to the first external electrode 131 on the third surface, and the first-second and second-second conductor portions 122-1 and 122-2 may be connected to the second external electrode 132 on the fourth surface.

As illustrated in FIG. 3, in a cross-section in the first and second directions polished to expose the first conductor portion EP1, the first-first and first-second conductor portions 121-1 and 122-1 may be alternately disposed in the first direction with the dielectric layer 111 interposed therebetween.

As illustrated in FIG. 5, in a cross-section in the first and second directions polished to expose the second conductor portion EP2, the second-first and second-second conductor portions 121-2 and 122-2 may be alternately disposed in the first direction with the dielectric layer 111 interposed therebetween.

In an example embodiment, the first separation portion SP1 and the second separation portion SP2 may be disposed to overlap each other in the first direction. Accordingly, heat generated in the body 110 may be more easily discharged to the outside of the body 110.

When the first separation portion SP1 and the second separation portion SP2 are disposed to overlap each other in the first direction, the first and second conductor portions EP1 and EP2 may not be observed in a cross-section in the first and second directions polished to expose the separation portion SP, as illustrated in FIG. 4.

However, the first separation portion SP1 and the second separation portion SP2 may not need to be disposed to overlap each other in the first direction, and may be disposed not to overlap each other in the first direction.

An average thickness (te) of the internal electrode is not limited. In this case, a thickness of each of the internal electrodes 121 and 122 may refer to a size in the first direction of the first conductor portion EP1 and/or the second conductor portion EP2.

However, in order to more easily achieve miniaturization and high capacitance of the multilayer electronic component, the average thickness of each of the internal electrodes 121 and 122 may be 0.4 μm or less.

Here, the average thickness (te) of the internal electrode may be measured by scanning, with an SEM, a cross-section in the first and second directions of the body 110 at a magnification of 10,000. More specifically, thicknesses of each of the internal electrodes 121 and 122 at multiple points, for example, thirty points spaced apart from each other at equal intervals in the second direction, may be measured to measure an average value thereof. The thirty points, spaced apart from each other at equal intervals, may be designated in the capacitance formation portion Ac. In addition, when such average value measurement is performed on ten internal electrodes 121 or ten internal electrodes 122, the average thickness of each of the internal electrodes 121 and 122 may be further generalized.

The external electrodes 131 and 132 may be disposed on the third and fourth surfaces 3 and 4 of the body 110, respectively.

The external electrodes 131 and 132 may be disposed on the third and fourth surfaces 3 and 4 of the body 110, respectively, and may include first and second external electrodes 131 and 132 respectively connected to the first and second internal electrodes 121 and 122.

Referring to FIG. 1, the external electrodes 131 and 132 may be disposed to cover both end surfaces in the second direction of each of the side margin portions 114 and 115.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

Each of the external electrodes 131 and 132 may be formed of any material having electrical conductivity, such as a metal or the like, and a specific material may be determined in consideration of electrical characteristics, structural stability, or the like. In addition, each of the external electrodes 131 and 132 may have a multilayer structure.

For example, the external electrodes 131 and 132 may include electrode layers 131a and 132a disposed on the body 110, and plating layers 131b and 132b formed on the electrode layers 131a and 132a.

As a more specific example of the electrode layers 131a and 132a, the electrode layers 131a and 132a may be a sintered electrode including a conductive metal and glass, or a resin-based electrode including a conductive metal and resin.

In addition, the electrode layers 131a and 132a may have a form in which a sintered electrode and a resin-based electrode are sequentially formed on a body. In addition, the electrode layers 131a and 132a may be formed by transferring a sheet including a conductive metal onto the body or by transferring a sheet including a conductive metal onto the sintered electrode.

A material having excellent electrical conductivity may be used as the conductive metal included in the electrode layers 131a and 132a, but the material is not limited. For example, the conductive metal may be at least one of nickel (Ni), copper (Cu), and an alloy thereof.

The plating layers 131b and 132b may serve to improve mounting characteristics. A type of each of the plating layers 131b and 132b is not limited, and each of the plating layers 131b and 132b may be a plating layer including at least one of Ni, Sn, Pd, and alloys thereof, and may be formed of a plurality of layers.

As a more specific example of the plating layers 131b and 132b, each of the plating layers 131b and 132b may be a Ni plating layer or a Sn plating layer, may have a form in which a Ni plating layer and a Sn plating layer are sequentially formed on the electrode layers 131a and 132a, and may have a form in which a Sn plating layer, a Ni plating layer, and a Sn plating layer are sequentially formed. In addition, each of the plating layers 131b and 132b may include a plurality of Ni plating layers and/or a plurality of Sn plating layers.

A size of the multilayer electronic component 100 is not limited.

For example, the multilayer electronic component 100 may have a size of 0603 (length×width, 0.6 mm×0.3 mm) or less. Considering a manufacturing error, external electrode size, or the like, the multilayer electronic component 100 may have a length of 0.66 mm or less and a width of 0.33 mm or less. Here, the length of the multilayer electronic component 100 refers to a maximum size in the second direction, and the width refers to a maximum size in the third direction.

Hereinafter, an example of a method for manufacturing the multilayer electronic component 100 according to an example embodiment of the present disclosure will be described. However, the method of manufacturing the multilayer electronic component 100 of the present disclosure is not limited thereto.

First, a ceramic slurry including ceramic powder particles, an organic solvent, and a binder may be coated on a carrier film 300 to form a ceramic green sheet.

An internal electrode pattern may be formed by printing an internal electrode conductive paste, including metal powder particles, a binder, an organic solvent, or the like, to a predetermined thickness on the ceramic green sheet using a screen-printing method or gravure-printing method.

In this case, the internal electrode conductive paste may be printed excluding a region in which the separation portion SP is to be disposed, such that, after sintering, the internal electrode includes the first and second conductor portions EP1 and EP2 disposed to be spaced apart from each other in the third direction with the separation portion SP interposed therebetween.

Subsequently, ceramic green sheets having the internal electrode pattern printed thereon may be laminated in the first direction to obtain a laminate. In this case, ceramic green sheets on which no internal electrode pattern is printed may be laminated on upper and lower portions of the laminate in order to form the cover portions 112 and 113 after sintering.

Subsequently, the laminate may be cut into unit laminates to have a predetermined chip size.

Subsequently, the unit laminates may be sintered to obtain a body. A sintering temperature may be, for example, 1000° C. or higher and 1400° C. or lower, but the present disclosure is not limited thereto.

Subsequently, the external electrodes 131 and 132 may be formed. For example, when the base electrode layers 131a and 132a include a sintered electrode layer, the body 110 may be dipped into a conductive paste for external electrodes including metal powder particles, glass frit, a binder, and an organic solvent, and then the conductive paste for external electrodes may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and then cured by heat treatment at a temperature of 250° C. to 550° C. to form the resin electrode layer.

In addition, the plating layers 131b and 132b may be formed on the base electrode layers 131a and 132a by further performing an electrolytic plating method and/or an electroless plating method.

### EXPERIMENTAL EXAMPLES

Sample chips having a 3216 size (length: about 3.2 mm, width: about 1.6 mm, thickness: about 1.6 mm) were prepared using the manufacturing method described above.

A sample chip, corresponding to each test number, was prepared to satisfy CW/W, MW1/W, MW2/W, and (A1+A2)/W as listed in Table 1 below.

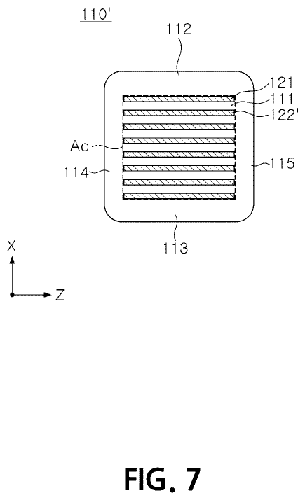

In Test Nos. 1 and 2, CW/W was 0, and internal electrodes 121′ and 122′ were formed as a single conductor portion, as illustrated in FIG. 7.

In Table 1 below, heat generation characteristics and high-temperature reliability for the sample chip corresponding to each test number were evaluated and described.

The heat generation characteristics were evaluated by mounting a sample chip on a PCB substrate, gradually increasing an applied voltage under conditions of an initial temperature of 105° C. and a frequency of 400 kHz, and measuring a voltage value at which a temperature of the sample chip reached 125° C. The voltage value when the temperature of the sample chip reached 125° C. was rated as follows: ⊚ when 850 V or more; ∘ when less than 850 V and 800 V or more; Δ when less than 800 V and 750 V or more; and X when less than 750 V.

The high-temperature reliability was evaluated by applying a temperature of 125° C. and a voltage of 100 V for 24 hours to 320 sample chips mounted on a PCB substrate. When an insulation resistance (IR) value of a sample chip was reduced by 3 orders or less relative to an initial value of the sample chip, the sample chip was determined as defective. The number of defective sample chips relative to the total number of sample chips was rated as follows: X when the number of defective chips is three or more; Δ when the number of defective chips is one to two, ∘ when the number of defective chips is zero.

TABLE 1

| Test No. | 1 | 2 | 3 | 4 | 5 | 6 | 7 | 8 |
|---|---|---|---|---|---|---|---|---|
| CW/W | 0 | 0 | 0.05 | 0.08 | 0.10 | 0.20 | 0.30 | 0.40 |
| MW1/W | 0.15 | 0.20 | 0.15 | 0.15 | 0.15 | 0.10 | 0.08 | 0.02 |
| MW2/W | 0.15 | 0.20 | 0.15 | 0.15 | 0.15 | 0.10 | 0.08 | 0.02 |
| (A1 + A2)/W | 0.70 | 0.60 | 0.65 | 0.62 | 0.60 | 0.60 | 0.54 | 0.58 |
| Heat | X | X | X | Δ | ◯ | ⊚ | Δ | X |
| generation | | | | | | | | |
| characteristics | | | | | | | | |
| High- | ◯ | ◯ | ◯ | ◯ | ◯ | ◯ | Δ | X |
| temperature | | | | | | | | |
| reliability | | | | | | | | |

As indicated in Table 1, it can be confirmed that Test numbers 5 and 6, satisfying all of 0.08<MW1/W<0.20, 0.08<MW2/W<0.20, and 0.08<CW/W<0.3, exhibit excellent heat generation characteristics.

Conversely, it can be confirmed that Test numbers 1 to 4, having CW/W of 0.08 or less, exhibited inferior heat generation characteristics, and test numbers 7 and 8, having CW/W of 0.3 or more, exhibit inferior heat generation characteristics and high-temperature reliability.

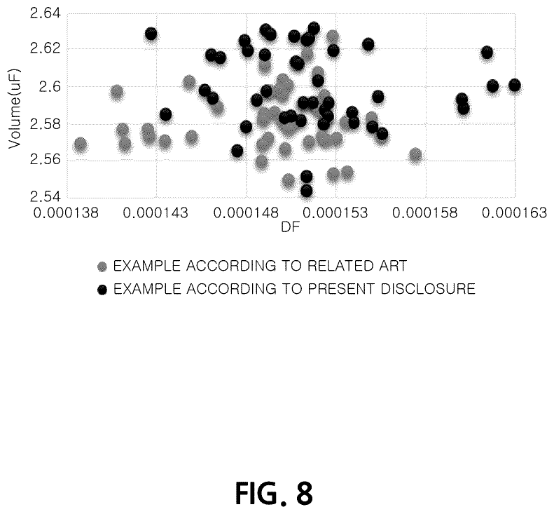

FIG. 8 is a graph comparing capacitances and dissipation factors (DFs) of 50 sample chips of Test No. 2 (example according to the related art) and 50 sample chips of Test No. 5 (example according to the present disclosure).

In FIG. 8, the capacitance and DF were measured under a condition of 1 kHz using an LCR meter. Referring to FIG. 8, it can be confirmed that the capacitance and DF of the example according to the present disclosure may be implemented similarly to those of the example according to the related art.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and an internal electrode alternately disposed with the dielectric layer in a first direction, the body having a first surface and a second surface opposing each other in the first direction, a third surface and a fourth surface connected to the first surface and the second surface, the third surface and the fourth surface opposing each other in a second direction, and a fifth surface and a sixth surface connected to the first to fourth surfaces, the fifth surface and the sixth surface opposing each other in a third direction; and
an external electrode disposed on the third surface and the fourth surface,
wherein the internal electrode includes first and second conductor portions disposed to be spaced apart from each other in the third direction with a separation portion interposed therebetween,
the body includes a first margin portion that is a region between the fifth surface and the internal electrode, and a second margin portion that is a region between the sixth surface and the internal electrode, and
when widths in the third direction of the body, the first margin portion, the separation portion, and the second margin portion are referred to as W, MW1, CW, and MW2, respectively, 0.08<MW1/W<0.20, 0.08<MW2/W<0.20, and 0.08<CW/W<0.30 are satisfied.

2. The multilayer electronic component of claim 1, wherein the W, the MW1, and the MW2 satisfy 0.10≤MW1/W≤0.15 and 0.10≤MW2/W≤0.15.

3. The multilayer electronic component of claim 1, wherein the W and the CW satisfy 0.10≤CW/W≤0.20.

4. The multilayer electronic component of claim 1, wherein the W, the MW1, the CW, and the MW2 satisfy 0.10≤MW1/W≤0.15, 0.10≤MW2/W≤0.15, and 0.10≤CW/W≤0.20.

5. The multilayer electronic component of claim 1, wherein (MW1+CW+MW2)/W satisfies 0.40 or less.

6. The multilayer electronic component of claim 1, wherein the MW1, the MW2, and the CW satisfy MW1<CW and MW2<CW.

7. The multilayer electronic component of claim 1, wherein, when widths in the third direction of the first and second conductor portions are referred to as A1 and A2, respectively, A1+A2 satisfies 0.60 or more.

8. The multilayer electronic component of claim 7, wherein the A1 and the A2 are different from each other.

9. The multilayer electronic component of claim 1, wherein the A1 and the A2 are substantially equal to each other.

10. The multilayer electronic component of claim 1, wherein
the internal electrode comprises a first internal electrode led out to the third surface, and a second internal electrode led out to the fourth surface,
the first internal electrode includes first-first and second-first conductor portions, disposed to be spaced apart from each other in the third direction, with a first separation portion interposed therebetween, and
the second internal electrode includes first-second and second-second conductor portions, disposed to be spaced apart from each other in the third direction, with a second separation portion interposed therebetween.

11. The multilayer electronic component of claim 10, wherein the first separation portion and the second separation portion are disposed to overlap each other in the first direction.

12. The multilayer electronic component of claim 10, wherein the first separation portion and the second separation portion are disposed not to overlap each other in the first direction.

13. The multilayer electronic component of claim 10, wherein an average thickness (te) of each of the first and second internal electrodes is 0.4 μm or less.
